(19) United States
(12) Patent Application Publication
(10) Pub. No.: US 2013/0216145 A1
(43) Pub. Date: Aug. 22, 2013

(54) APPARATUS AND METHOD FOR PROCESSING IMAGE DATA USING CUT THROUGH MEMORY

(71) Applicant: Electronics and Telecommunications Research Institute, (US)

(72) Inventors: Yoo-Kyoung LEE, Daejeon (KR); Nak Woong Eum, Daejeon (KR); Hee-Bum Jung, Daejeon (KR)

(73) Assignee: Electronics and Telecommunications Research Institute, Daejeon (KR)

(21) Appl. No.: 13/675,616

(22) Filed: Nov. 13, 2012

(30) Foreign Application Priority Data
Feb. 16, 2012 (KR) 10-2012-0015696

(51) Int. Cl. G06T 1/60; G06T 9/00

(52) U.S. Cl. CPC G06T 1/60; G06T 9/00
USPC 382/233; 345/555

(57) ABSTRACT

Disclosed is an apparatus for processing an image data including: a CPU, a system memory connected with the CPU through a system bus, a communication packet processing unit configured to receive packet data from an external network, and a cut through memory configured to be connected with the communication packet processing unit through the system bus and a cut through memory bus and include a cut through memory storing the received packet data.

### CROSS-REFERENCES TO RELATED APPLICATIONS

The present application claims priority under 35 U.S.C 119(a) to Korean Application No. 10-2012-0015696, filed on Feb. 16, 2012, in the Korean Intellectual Property Office, which is incorporated herein by reference in its entirety set forth in full.

### BACKGROUND

Exemplar embodiments relate to a low-power and high-resolution time-to-digital converter, and more particularly, to a low-power and high-resolution time-to-digital converter configured to detect a phase error between a retimed reference clock and a reference clock.

A charge pump PPL (Phase Locked Loop) has been generally used to design RF frequency synthesizer for multiband mobile communication in the related art and analog circuit design technologies are integrated in the charge pump PPL. Accordingly, a specific additional analog/RF library is required, other than an analog circuit and a design library that is provided in a standard digital CMOS process due to analog signal characteristics, so that it is difficult to integrate with a digital baseband signal processing block.

Further, as a nanoscale digital CMOS process has been recently developed, digital baseband signal processing blocks have also been increasingly developed by using the nanoscale digital CMOS process. With the change of development of the nanotechnology, digital circuits can be implemented by being easily adopted to a process technology for desired manufacturing, substantially without redesigning, but there is a problem in that it is necessary to redesign the analogy/RF integrated circuit every time the process technology is changed, and there is a defect in that an operation voltage decreases, as the CMOS process technology is correspondingly developed into the nanoscale.

Therefore, it takes a lot of time and cost to improve various problems in designing the analog/RF integrated circuit in the nanoscale digital CMOS process, so that researches about digital RF that gradually digitalizes the analog/RF circuit have been intensively conducted. In particular, the frequency synthesizer in the RF transceivers is a part that can be completely digitalized. Although the digital PLL frequency synthesizer has a long history, but the phase noise and the jitter characteristics are poor, so that the digital PLL frequency synthesizer has not been substantially used for the local oscillator of RF transceiver for mobile communication that requires high-quality phase noise.

However, a new type of ADPLL (all digital PLL) was developed a few years ago by applying the digital PLL technology to a frequency synthesizer for mobile communication. The difference between the ADPLL and the digital PLL of the related art is the DCO (Digitally Controlled Oscillator), and the past DCO oscillator of the related art is implemented by using a digital logic but the recent DCO oscillator is implemented by using an LC resonator. Therefore, since the DCO is designed by using an LC resonator, the phase noise or the jitter noise is very excellent more than the DCO using the past digital logic.

Since the DCO oscillator using an LC resonator controls the oscillation frequency by controlling a fine amount of change in capacitance of the LC resonator, the capacitor bank is divided into a coarse control bank and a fine control bank. The coarse control bank of the DCO is used to quickly find a PLL lock for a desired PLL frequency and is converted into the fine control bank by a mode conversion signal when the objective PLL frequency is almost reached by the coarse control bank, in which the fine control bank is used and the objective PLL frequency is locked by fine tracking.

The fractional phase error ε that is used for the fine tracking is generated by a time-to-digital converter a fine phase difference between the reference signal and DCO output signal is compensated through an arithmetical operation phase detector by a fractional phase error signal.

In this case, the phase noise performance of the existing digital PLL is determined by the resolution of the fractional phase error ε that the time-to-digital converter can detect. That is, the higher the detected resolution of the fractional phase error ε of the time-to-digital converter, the more the phase noise becomes good, and the phase error detection resolution is determined by the minimum inverter delay time of an inverter chain constituting the time-to-digital converter. However, as disclosed in Korean Patent Publication No. 2010-0130205, the inverter chain of time-to-digital converters that has been invented before has a defect in that power consumption and noise contribution are large, because the inverter chain should operate at a high DCO clock frequency.

The technical field of the present invention is disclosed in a ‘high-speed time-digital converter’ disclosed in Korean Patent Publication No. 10-2010-0130205 (2010, Dec. 10).

### SUMMARY

An embodiment of the present invention is directed to an apparatus and a method for processing an image data using a cut through memory having HTML5 message hardware for reducing a CPU load and a cut through memory configuration for reducing a memory copy frequency at the time of processing data.

Another embodiment of the present invention is to minimize a load of a system bus directly connected with a CPU by separately configuring a memory for processing an image data and a bus (cut through memory bus) so as to reduce an overhead of a system bus.

An embodiment of the present invention relates to an apparatus for processing an image data, including: a communication packet processing unit configured to receive packet data from an external network; and a cut through memory configured to be connected with the communication packet processing unit through a cut through memory bus and to store the received packet data.

The apparatus may further include: when there is a video tag in an HTML message included in the packet data stored in the cut through memory, a bus bridging/message processing unit configured to store an image data corresponding to the video tag in the cut through memory.

The bus bridging/message processing unit may include: a system bus control unit configured to be connected with a data bus, an address bus, and a bus control bus that are connected with a system bus and perform a slave operation of the system bus; a cut through memory bus control unit configured to be connected with a data bus, an address bus, and a bus control bus that are connected with the cut through memory bus and perform a master operation controlling the cut through memory bus; a bus bridging unit configured to connect the system bus with the cut through memory bus; and image data control unit configured to transfer image data stored in the cut through memory to an image decoding unit for decoding.

The apparatus may further include: a control information memory configured to be located in the bus bridging unit area and store control information for a CPU to control any one of the communication packet processing unit, the image decoding unit, and the cut through memory.

The cut through memory may include a memory access pointer connected with the packet data and an image data separated from the HTML message data

The communication packet processing unit and the cut through memory may be formed of system semiconductor of single chip.

Another embodiment of the present invention relates to a method for processing an image data, including: receiving, by a communication packet processing unit, a TCP/IP packet data from a network; storing the received TCP/IP packet data in a cut through memory connected with the communication packet processing unit through a cut through memory; storing an image data corresponding to a video tag in the cut through memory, when a video tag is present in an HTML message included in the stored TCP/IP packet data; transferring the image data stored in the cut through memory to an image decoding unit connected with the cut through memory through the cut through memory bus so as to decode the image data; and decoding, by the image decoding unit, the image data so as to be imaged.

The method may further include: prior to the transferring of the image data to the image decoding unit, extracting the image data from a system memory connected with a CPU through a system bus and storing the extracted image data in the cut through memory.

### BRIEF DESCRIPTION OF THE DRAWINGS

The above and other aspects, features and other advantages will be more clearly understood from the following detailed description taken in conjunction with the accompanying drawings, in which:

FIG. 1 is a block configuration diagram of an apparatus for processing an image data using a CPU and a system memory in accordance with the related art;

FIG. 2 is a block configuration diagram of an apparatus for processing an image data using a cut through memory in accordance with an embodiment of the present invention;

FIG. 3 is a diagram illustrating a cut through memory configuration of an apparatus for processing an image data in accordance with the embodiment of the present invention;

FIG. 4 is a block configuration diagram of a bus bridging/message processing unit in accordance with an embodiment of the present invention; and

FIG. 5 is a diagram illustrating a data transfer path of the apparatus for processing an image data using a cut through memory in accordance with an embodiment of the present invention.

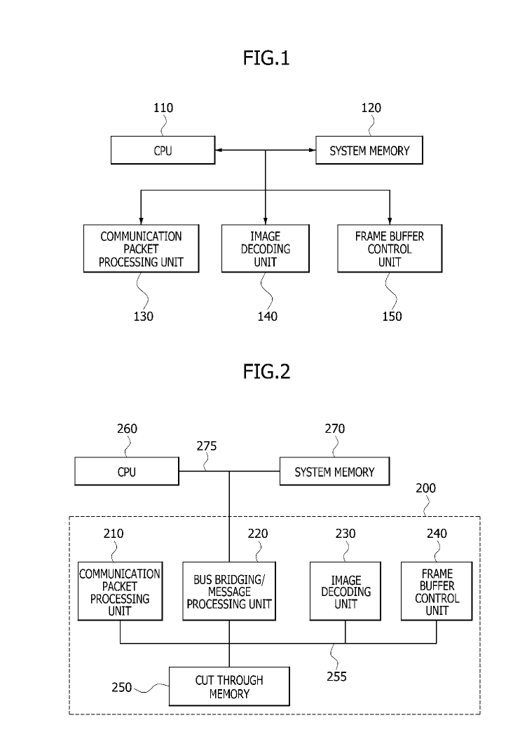

### DESCRIPTION OF SPECIFIC EMBODIMENTS

Hereinafter, an apparatus and a method for processing an image data using a cut through memory in accordance with an embodiment of the present invention will be described with reference to the accompanying drawings. In describing the present invention, the thickness of lines, the sizes, shapes, or the like of components illustrated in the drawings may be exaggerated or simplified for clarity and convenience. Further, the terminologies specifically defined in consideration of the configuration and functions of the present invention may be construed in different ways by the intention of users and operators. Therefore, the definitions thereof should be construed based on the contents throughout the specification.

FIG. 2 is a block configuration diagram of an apparatus for processing an image data using a cut through memory in accordance with an embodiment of the present invention.

Referring to FIG. 2, the apparatus for processing an image data using a cut through memory in accordance with an embodiment of the present invention includes a communication packet processing unit 210, a bus bridging/message processing unit 220, an image decoding unit 230, a frame buffer control unit 240, a cut through memory 250, a cut through memory bus 255, a CPU 260, a system memory 270, and a system bus 275.

In this configuration, the communication packet processing unit, the bus bridging/message processing unit 220, the image decoding unit 230, the frame buffer control unit 240, and the cut through memory 250 are separately connected with each other through the cut through memory bus 255 and the CPU 260 and the system memory 270 are connected with each other through the system bus 275.

Hereinafter, the present invention mainly describe a case in which the communication packet processing unit 210 is TCP/IP packet processing hardware and the bus bridging/message processing unit 220 is hardware processing an HTML message, but is not limited thereto. Therefore, the present invention may be applied to web documents written with other protocols or other languages.

The technical field relating to the present invention may be an HTML hardware engine technology for increasing processing performance of a CPU, an image data cut through memory bus technology for reducing an overload of a system bus, and a technology of implementing a system semiconductor chip (SoC) by hardware.

The embodiment of the present invention relates to an efficient method for reducing a copy frequency for effectively processing a large-capacity memory copy among an TCP/IP engine required to process multimedia of the Internet, an image decoder engine, and a frame buffer, increasing processing performance of a CPU by reducing collision of a system bus, and processing and displaying an image in real time.

A TCP/IP packet input through an external network, for example, the Internet is stored in a cut through memory 250 area through the communication packet processing unit 210 and the stored TCP/IP packet is informed to the bus bridging/message processing unit 220 using a memory pointer.

The bus bridging/message processing unit 220 confirms a web document in the TCP/IP packet, for example, a location of the HTML page and an HTML5 message parser unit 223 to be described below parses a message and stores an image data encoded by a video tag in the cut through memory 250 area.

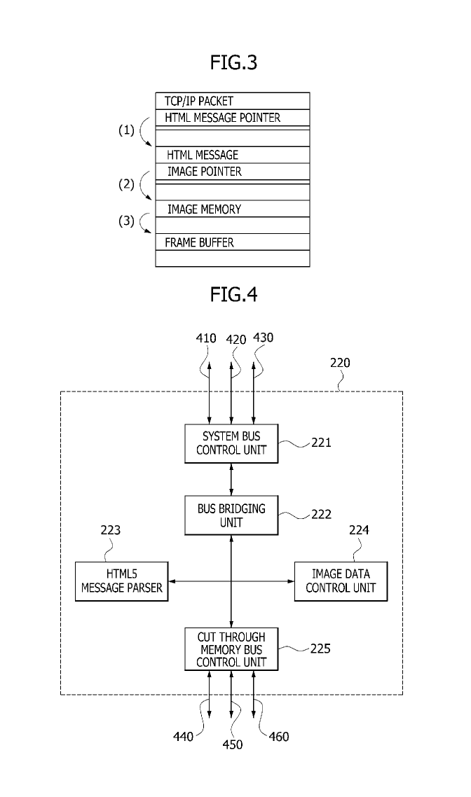

A method for configuring a memory access pointer stored in the memory area manages a memory in a linked list queue type connected by pointers as illustrated in 1), 2), and 3) of FIG. 3.

FIG. 4 is a block configuration diagram of a bus bridging/message processing unit in accordance with an embodiment of the present invention.

As illustrated in FIG. 4, the bus bridging/message processing unit 220 includes a system bus control unit 221, a bus bridging unit 222, an HTML5 message parser unit 223, an image data control unit 224, a cut through memory bus control unit 225, address buses 410 and 440, data buses 420 and 450, and bus control buses 430 and 460.

The system bus control unit 221 connects the data bus 420 of 32 bits, the address bus 410 of 32 bits, and the bus control bus 430 with the system bus 275 side to perform a slave operation of the system bus 275.

The cut through memory bus control unit 225 couples the data bus 450 of 32 bits, the address bus 440 of 32 bits, and the bus control bus 460 controlling the cut through memory bus 255 with the cut through memory bus 255 side and performs a bus master function controlling the cut through memory bus 255.

The bus bridging unit 222 may transparently connect the system bus 275 with the cut through memory bus 255 to control the communication packet processing unit 210 in which the CPU 260 is connected with the cut through memory bus 255, the image decoding unit 230, the frame buffer control unit 240, and the cut through memory 250.

In accordance with the embodiment of the present invention, a functional block or a separate area of the bus bridging unit 222 may further include a separate control information memory (not illustrated) area, in which each hardware and memory related data can be stored, so as for the CPU 260 to conveniently control each function unit. The control information memory area is configured by 256 bytes for each hardware and therefore, may be configured of a total of 1024 bytes as 256 bytes×4. The CPU 260 may directly access the communication packet processing unit 210, the image decoding unit 230, the frame buffer control unit 240, and the cut through memory 250 through the bus bridging unit 222.

The HTML5 message parser 223 may extract and parse the HTML5 message from the TCP/IP packet and parse the image data information within the message and transfer the image data to the image decoding unit 230 through the image data control unit 224.

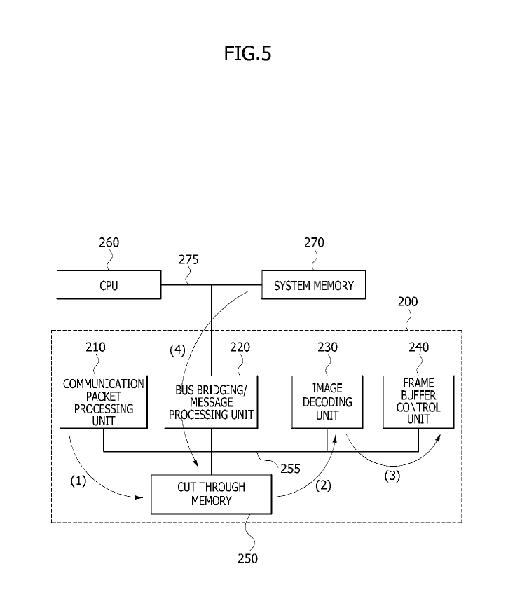

FIG. 5 is a diagram illustrating a data transfer path of the apparatus for processing an image data using a cut through memory in accordance with an embodiment of the present invention. FIG. 5 illustrates in detail a method for processing an HTML5 message.

First, when the TCP/IP packet is reached through the Internet, the communication packet processing unit 210 stores the reached TCP/IP packet in the cut through memory 250 for image processing ((1)).

Thereafter, the bridging/message processing unit 220 parses the stored TCP/IP packet and separately stores the image data in the cut through memory 250 when the video tag is present in the HTML message included in the TCP/IP packet and transfers the stored image data to the image decoding unit 230, which is then decoded.

The image decoding unit 230 decodes the image and transfers the decoded image to the frame buffer control unit 240 ((3)), thereby displaying the image.

When the CPU 260 decodes and displays the image data in the system memory 270, the CPU 260 moves the corresponding image data to the cut through memory 250 for image processing through the bus bridging/message processing unit 220 and then, processes the moving image data by the method, such as the above-mentioned methods, thereby displaying an image.

The embodiments of the present invention separate the cut through memory bus from the system bus so as to effectively process the image data on the HTML5 message of the Internet and reduce the load of the system bus of the CPU, thereby reducing the load of image processing to increase the processing performance of the system and effectively processing the HTML5 message including the multimedia.

Although the present invention has been described in detail with reference to the embodiments illustrated in the drawings, they are only examples. It will be appreciated by those skilled in the art that various modifications and equivalent other embodiments are possible from the present invention. Accordingly, the actual technical protection scope of the present invention must be determined by the spirit of the appended claims.

What is claimed is:

1. An apparatus for processing an image data, comprising:
a communication packet processing unit configured to receive packet data from an external network; and
a cut through memory configured to be connected with the communication packet processing unit through a cut through memory bus and to store the received packet data.

2. The apparatus of claim 2, further comprising: a bus bridging/message processing unit configured to store an image data corresponding to a video tag in the cut through memory when there is the video tag in an HTML message included in the packet data stored in the cut through memory.

3. The apparatus of claim 2, wherein the bus bridging/message processing unit includes:
a system bus control unit configured to be connected with a data bus, an address bus, and a bus control bus that are connected with a system bus and perform a slave operation of the system bus;
a cut through memory bus control unit configured to be connected with a data bus, an address bus, and a bus control bus that are connected with the cut through memory bus and perform a master operation controlling the cut through memory bus;
a bus bridging unit configured to connect the system bus with the cut through memory bus; and
image data control unit configured to transfer image data stored in the cut through memory to an image decoding unit for decoding.

4. The apparatus of claim 3, further comprising: a control information memory configured to be located in the bus bridging unit area and store control information for a CPU to control any one of the communication packet processing unit, the image decoding unit, and the cut through memory.

5. The apparatus of claim 2, wherein the cut through memory includes a memory access pointer connected with the packet data and an image data separated from the HTML message data.

6. The apparatus of claim 1, wherein the communication packet processing unit and the cut through memory are formed of system semiconductor of single chip.

7. A method for processing an image data, comprising:
receiving, by a communication packet processing unit, a TCP/IP packet data from a network;
storing the received TCP/IP packet data in a cut through memory connected with the communication packet processing unit through a cut through memory;
storing an image data corresponding to a video tag in the cut through memory, when the video tag is present in an HTML message included in the stored TCP/IP packet data;
transferring the image data stored in the cut through memory to an image decoding unit connected with the cut through memory through the cut through memory bus so as to decode the image data; and
decoding, by the image decoding unit, the image data so as to be imaged.

8. The method of claim 7, further comprising: prior to the transferring of the image data to the image decoding unit, extracting the image data from a system memory connected with a CPU through a system bus and storing the extracted image data in the cut through memory.
